(19) United States
(12) Patent Application Publication
(10) Pub. No.: US 2019/0204143 A1
(43) Pub. Date: Jul. 4, 2019

(54) METHOD AND DEVICE FOR MONITORING IDLE MACHINING OF PROCESSING MACHINE

(71) Applicant: Chung Yuan Christian University, Taoyuan City (TW)

(72) Inventors: Shih-Ming WANG, Taoyuan City (TW); Chun-Yi LEE, Taoyuan City (TW)

(21) Appl. No.: 15/990,293

(22) Filed: May 25, 2018

(30) Foreign Application Priority Data
Dec. 29, 2017 (TW) 106146368

(51) Int. Cl. G01H 11/06

(52) U.S. Cl. CPC G01H 11/06; G05B 19/4063

(57) ABSTRACT

A method for monitoring idle machining of a processing machine includes the following steps. A spindle load current of the processing machine is monitored to generate a load current change state. A cutting vibration signal of the processing machine is monitored to generate a vibration signal change state. A cutting instruction of the processing machine is obtained to generate a processing section change state. A processing time, a cutting time and an idle time are calculated according to the load current change state, the vibration signal change state and the processing section change state.

### CROSS REFERENCE TO RELATED APPLICATION

This application claims the priority benefit of Taiwan Patent Application Serial Number 106146368, filed on Dec. 29, 2017, the full disclosure of which is incorporated herein by reference.

### BACKGROUND

### Technical Field

This present disclosure generally relates to a method and a device for monitoring and, more particularly, to a method and a device for monitoring idle machining of a processing machine.

### Related Art

In general, when the computer numerical control (CNC) machine performs the cutting processing, the main factors that cause invalid cutting are the position of the rapid positioning of the processing machine being too far from the cutting workpiece, or the screw error, the backlash error or the positioning error of the machine itself and so on, thereby increasing the redundant invalid cutting movement distance.

However, the error of the processing machine itself results in redundant or insufficient movement distance, all causing the processed product to be incompliant with the standard size. If the processed product is overcut, the processed product must be scrapped. It not only loses the cost of the product but also unknowingly wastes a lot of processing time. Further, if this is discovered after a large number of processed products are manufactured, it may result in tremendous losses. The cutting fluid is often added for use as coolant and lubricant during the processing. However, it may be incapable to effectively observe if there is overcut or undercut in the processing.

If the idle time of each part when processing can be known during the processing, we may know whether abnormal processing and the idle machining thereof exist, and may also modify and optimize the abnormal part, thereby improving the processing efficiency, early discovering the abnormal situation, and reducing the loss. Therefore, it is desirous for the various manufactures to study how to effectively know the idle time when processing.

### SUMMARY

The present disclosure provides a method and a device for monitoring idle machining of a processing machine, thereby quickly and effectively calculating the idle machining corresponding to the processing machine and improving the processing efficiency and increasing the convenience of usage.

The present disclosure provides a method for monitoring idle machining of a processing machine, which includes the following steps. A spindle load current of the processing machine is monitored to generate a load current change state. A cutting vibration signal of the processing machine is monitored to generate a vibration signal change state. A cutting instruction of the processing machine is obtained to generate a processing section change state. A processing time, a cutting time and an idle time are calculated according to the load current change state, the vibration signal change state and the processing section change state.

The present disclosure provides a device for monitoring idle machining of a processing machine, which includes a first monitoring module, a second monitoring module, an obtaining module and a calculating module. The first monitoring module monitors a spindle load current of the processing machine to generate a load current change state. The second monitoring module monitors a cutting vibration signal of the processing machine to generate a vibration signal change state. The obtaining module obtains a cutting instruction of the processing machine to generate a processing section change state. The calculating module is coupled to the first monitoring module, the second monitoring module and the obtaining module, and calculates a processing time, a cutting time and an idle time according to the load current change state, the vibration signal change state and the processing section change state.

According to the method and the device for monitoring idle machining of the processing machine of the embodiments of the present disclosure, the spindle load current of the processing machine is monitored to generate the load current change state, the cutting vibration signal of the processing machine is monitored to generate the vibration signal change state, the cutting instruction of the processing machine is obtained to generate the processing section change state, and the processing time, the cutting time and the idle time are calculated according to the load current change state, the vibration signal change state and the processing section change state. Therefore, an idle machining corresponding to the processing machine is quickly and effectively calculated, the processing efficiency is improved and the convenience of usage is increased.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a schematic view of a device for monitoring idle machining of a processing machine according to an embodiment of the present disclosure; and

FIG. 2 shows a flowchart of a method for monitoring idle machining of a processing machine according to an embodiment of the present disclosure.

### DETAILED DESCRIPTION OF THE EMBODIMENTS

The present disclosure will now be described more fully hereinafter with reference to the accompanying drawings, in which exemplary embodiments of the invention are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substaintial/substaintially” means, within an acceptable error range, the person skilled in the art may solve the technical problem in a certain error range to achieve the basic technical effect. Additionally the term “couple” or “connect” covers any direct or indirect electrically coupling means. Therefore when one device is electrically connected to another device in the context, that connection may be through a direct electrical connection, or through an indirect electrical connection via other devices and connections. The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals is used to refer to the same or similar elements throughout.

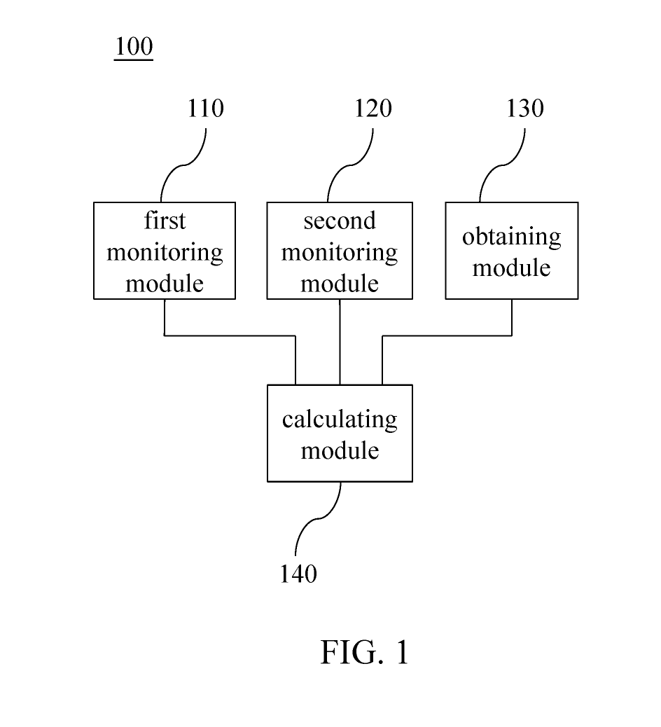

FIG. 1 shows a schematic view of a device for monitoring idle machining of a processing machine according to an embodiment of the present disclosure. The processing machine is, for example, a CNC processing machine. The device for monitoring idle machining of the processing machine 100 includes a first monitoring module 110, a second monitoring module 120, an obtaining module 130 and a calculating module 140.

The first monitoring module 110 monitors a spindle load current of the processing machine to generate a load current change state. That is, the first monitoring module 110 monitors a generation time and an ending time of the spindle load current of the processing machine, and makes a section between the generation and the ending time as the load current change state accordingly. Wherein the load current change state records the generation time and ending time of the spindle load current.

In the embodiment, the generation time of the spindle load current is, for example, the spindle load current greater than an initial current value. The ending time of the spindle load current is, for example, the spindle load current equal to the initial current value. Wherein the initial current value is, for example, a motor current when the spindle is idle, such as the spindle load current being 0%. For example, when the first monitoring module 110 monitors that the spindle load current is greater than the initial current value, the first monitoring module 110 may determine a cutting state and record a time point of this time as L1. When the first monitoring module 110 monitors that the spindle load current lowers to equal to the initial current value from the spindle load current greater than the initial current value, the first monitoring module 110 may determine a non-cutting state and record a time point of this time as L2.

The second monitoring module 120 monitors a cutting vibration signal of the processing machine to generate a vibration signal change state. That is, the second monitoring module 120 monitors a generation time and an ending time of the cutting vibration signal of the processing machine and makes a second between the generation time and the ending time as the vibration signal change state accordingly. Wherein the vibration signal change state records the generation time and the ending time of the cutting vibration signal.

In the embodiment, the generation time of the cutting vibration signal is, for example, the cutting vibration signal greater than an initial cutting vibration value. The ending time of the cutting vibration signal is, for example, the cutting vibration signal equal to the initial cutting vibration signal. Wherein the initial cutting vibration value is a motor vibration value when the spindle is idle.

For example, the second monitoring module 120 monitoring the cutting vibration signal is that a root mean square process is performed for the cutting vibration signal to determine accordingly. Since a value of the original cutting vibration signal beats between a positive value and a negative value and the characteristic thereof is not easy to be directly seen, after performing the root mean square for the above value, it may clearly determine whether the cutting vibration signal is at the cutting state and may not cause a miscarriage of justice. For example, as long as during the processing process, the second monitoring module 120 monitors that the cutting vibration signal is greater than the initial cutting vibration value, it indicates that the processing machine is at the cutting state at this time, and a time point of this time is recorded as L1. Similarly, when the second monitoring module 120 monitors that the cutting vibration signal is equal to or less than the initial cutting vibration value, it indicates that the processing machine is at a non-cutting state, and a time point of this time is recorded as L2, and the L2 serves as a calculation and usage of the subsequent processing time.

The obtaining module 130 obtains a cutting instruction of the processing machine to generate a processing section change state. In the embodiment, the obtaining module 130 obtains, for example, the cutting instruction of the processing machine from the CNC controller. After the current instruction of the processing machine is obtained, the cutting instruction is, for example, identified through a regular expression, so as to obtain an NC program code in the cutting instruction and then generate the processing section change state accordingly. The regular expression is a way of expressing a string of “some rules”. It may be used to completely specify the data to be processed. The expression is mainly used to find a specific and regular string in a large amount of data, so as to avoid a trouble of the repeated determination and searching.

Additionally, the NC program code includes, for example, G00, G01, G02 and G03. G00 is mainly used in a fast moving positioning. This state means idle time, i.e. the processing time is idle time and there is no cutting time. G01, G02 and G03 are the NC program core for cutting. Therefore, when the processing state of the processing machine is one of G01, G02 and G03, it may determine whether the processing machine enters the cutting machine.

Furthermore, the processing section change state is that one cutting instruction is transformed to another cutting instruction. For example, when the cutting instruction performed currently is G01, a time point of this time is recorded as T1. Then, the obtaining module 130 may continue to obtain the cutting instruction. When the cutting instruction performed currently is G02, it means that one cutting instruction has been transformed to another cutting instruction. A time point of this time is recorded as T2 and a section between two time points T1 and T2 is made as the processing section change state. For the transformation and the corresponding processing section change state of other cutting instruction (such as, G00, G02 or G03), it may refer to the above description, and the description thereof is omitted.

The calculating module 140 is coupled to the first monitoring module 110, the second monitoring module 120 and the obtaining module 130, receives the load current change state, the vibration signal change state and the processing section change state and calculates a processing time, a cutting time and an idle time according to the load current change state, the vibration signal change state and the processing section change state.

In the embodiment, the processing time is, for example, the processing section change state. A time length of the processing section change state is served as the processing time of this section. For example, when the time point corresponding to the cutting instruction G01 is T1 and the time point corresponding to another cutting instruction (such as, G00, G02 or G03) is T2, the calculating module 140 accordingly calculate the total processing time of the processing section corresponding to the cutting instruction G01 as T2-T1. Similarly, the calculation method of the processing time of the processing section corresponding to the cutting instructions G00, G02 and G03 calculated by the calculating module 140 is the same as the calculation method of the cutting instruction G01. It may refer to the calculation method of the cutting instruction G01, and the description thereof is omitted.

Additionally, the cutting time is that the load current change state returns to an initial current value from the spindle current change exceeding the initial current value and the vibration signal change state returns to an initial cutting vibration value from the current vibration signal exceeding the initial cutting vibration value.

For example, determining the spindle load current is taken as an example. The spindle load current under the cutting instruction G01, G02 or G03 is greater than the initial current value. Assuming that the cutting instruction performed currently is G01, the first monitoring module 110 may monitor the spindle load current. When the first monitoring module 110 monitors that the spindle load current is greater than the initial current value, the first monitoring module 110 may determine the cutting state and record the time point of this time as L1. When the first monitoring module 110 monitors that the spindle load current lowers to equal to the initial current value from the spindle load current greater than the initial current value, the first monitoring module 110 may determine the non-cutting state and record the time point of this time as L2.

Then, when the calculating module 140 receives the load current change state, i.e. the time points L1 and L2, the calculating module 140 may accordingly calculate an effective cutting time corresponding to the cutting instruction G01 as L2−L1. Similarly, the calculation method of the effective cutting time corresponding to the cutting instructions G02 and G03 calculated by the calculating module 140 is the same as the calculation method of the cutting instruction G01, it may refer to the calculation method of the cutting instruction G01, and the description thereof is omitted. The method of the cutting time calculated by the calculating module 140 through the vibration signal change state is the same as the method of the cutting time calculated through the load current change state. It may refer to the method of the cutting time calculated through the load current change state, and the description thereof is omitted.

Furthermore, the idle time is the processing time minus the cutting time. That is, when the calculating module 140 calculates the processing time T2−T1 and the cutting time L2−L1, the calculating module 140, the processing time T2−T1 may be subtracted from the cutting time L2−L1, so as to calculate the idle time corresponding to the cutting instruction G01.

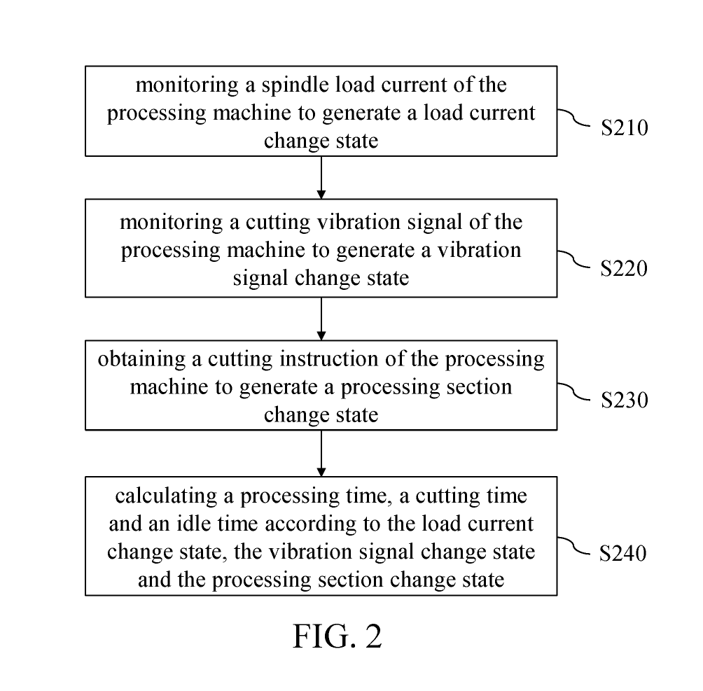

According to the above description of the embodiment, it may sum up a method for monitoring idle machining of the processing machine. FIG. 2 shows a flowchart of a method for monitoring idle machining of a processing machine according to an embodiment of the present disclosure.

In step S210, the method involves monitoring a spindle load current of the processing machine to generate a load current change state. In step S220, the method involves monitoring a cutting vibration signal of the processing machine to generate a vibration signal change state. In step S230, the method involves obtaining a cutting instruction of the processing machine to generate a processing section change state. In step S240, the method involves calculating a processing time, a cutting time and an idle time according to the load current change state, the vibration signal change state and the processing section change state.

In the embodiment, the processing section change state is that one cutting instruction is transformed to another cutting instruction. The processing time is the processing section change state. The cutting time is that the load current change state returns to an initial current value from the spindle current change exceeding the initial current value and the vibration signal change state returns to an initial cutting vibration value from the current vibration signal exceeding the initial cutting vibration value. The idle time is the processing time minus the cutting time. The initial current value is a motor current when the spindle is idle. The initial cutting vibration value is a motor vibration value when the spindle is idle.

As mentioned above, according to the method and the device for monitoring idle machining of the processing machine of the embodiments of the present disclosure, the spindle load current of the processing machine is monitored to generate the load current change state, the cutting vibration signal of the processing machine is monitored to generate the vibration signal change state, the cutting instruction of the processing machine is obtained to generate the processing section change state, and the processing time, the cutting time and the idle time are calculated according to the load current change state, the vibration signal change state and the processing section change state. Therefore, the idle machining corresponding to the processing machine is quickly and effectively calculated, the processing efficiency is improved and the convenience of usage is increased.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A method for monitoring idle machining of a processing machine, comprising:
monitoring a spindle load current of the processing machine to generate a load current change state;
monitoring a cutting vibration signal of the processing machine to generate a vibration signal change state;
obtaining a cutting instruction of the processing machine to generate a processing section change state; and
calculating a processing time, a cutting time and an idle time according to the load current change state, the vibration signal change state and the processing section change state.

2. The method for monitoring idle machining of the processing machine as claimed in claim 1, wherein the processing section change state is that one cutting instruction is transformed to another cutting instruction.

3. The method for monitoring idle machining of the processing machine as claimed in claim 2, wherein the processing time is the processing section change state.

4. The method for monitoring idle machining of the processing machine as claimed in claim 2, wherein the cutting time is that the load current change state returns to an initial current value from the spindle current change exceeding the initial current value and the vibration signal change state returns to an initial cutting vibration value from the current vibration signal exceeding the initial cutting vibration value.

5. The method for monitoring idle machining of the processing machine as claimed in claim 4, wherein the idle time is the processing time minus the cutting time.

6. The method for monitoring idle machining of the processing machine as claimed in claim 4, wherein the initial current value is a motor current when the spindle is idle.

7. The method for monitoring idle machining of the processing machine as claimed in claim 4, wherein the initial cutting vibration value is a motor vibration value when the spindle is idle.

8. A device for monitoring idle machining of a processing machine, comprising:
a first monitoring module, for monitoring a spindle load current of the processing machine to generate a load current change state;
a second monitoring module, for monitoring a cutting vibration signal of the processing machine to generate a vibration signal change state;
an obtaining module, for obtaining a cutting instruction of the processing machine to generate a processing section change state; and
a calculating module, coupled to the first monitoring module, the second monitoring module and the obtaining module, for calculating a processing time, a cutting time and an idle time according to the load current change state, the vibration signal change state and the processing section change state.

9. The device for monitoring idle machining of the processing machine as claimed in claim 8, wherein the processing section change state is that one cutting instruction is transformed to another cutting instruction.

10. The device for monitoring idle machining of the processing machine as claimed in claim 9, wherein the processing time is the processing section change state, a processing unit, connected to the detecting electrode and receiving the detecting signal to generate a processing signal;

11. The device for monitoring idle machining of the processing machine as claimed in claim 9, wherein the cutting time is that the load current change state returns to an initial current value from the spindle current change exceeding the initial current value and the vibration signal change state returns to an initial cutting vibration value from the current vibration signal exceeding the initial cutting vibration value.

12. The device for monitoring idle machining of the processing machine as claimed in claim 11, wherein the idle time is the processing time minus the cutting time.

13. The device for monitoring idle machining of the processing machine as claimed in claim 11, wherein the initial current value is a motor current when the spindle is idle.

14. The device for monitoring idle machining of the processing machine as claimed in claim 11, wherein the initial cutting vibration value is a motor vibration value when the spindle is idle.
